(19) United States
(12) Patent Application Publication
(10) Pub. No.: US 2026/0317519 A1
(43) Pub. Date: Oct. 15, 2026

(54) MELT-PROCESSIBLE COMPOSITIONS CONTAINING POLYMER PROCESSING ADDITIVES AND LIGHT STABLIZERS

(71) Applicant: 3M INNOVATIVE PROPERTIES COMPANY, St. Paul, MN (US)

(72) Inventors: Kim Van de Velde, Zwijndrecht (BE); Ingrid Haesendonckx, Antwerpen (BE)

(21) Appl. No.: 19/480,599

(22) PCT Filed: Apr. 4, 2024
(86) PCT No.: PCT/IB2024/053313

§ 371 Date: Oct. 31, 2025

Related U.S. Application Data
(60) Provisional application No. 63/500,117, filed on May 4, 2023.

(51) Int. Cl. C08L 23/06; C08J 5/18; C08K 5/17

(52) U.S. Cl. CPC C08L 23/06; C08J 5/18; C08K 5/17; C08J 2323/06; C08J 2423/06; C08J 2467/02; C08J 2467/04; C08J 2471/02; C08L 2201/08; C08L 2203/16; C08L 2205/025; C08L 2205/03; C08L 2207/066

(57) ABSTRACT

Compositions comprising one or more thermoplastic hydrocarbon polymers and high levels of a hindered amine light stabilizer are described. The compositions include a polymer processing additive composition comprising a hyperbranched polyester polyol and a synergist for the hyperbranched polyester polyol selected from the group consisting of polyethylene glycols and poly(ethylene oxide)s.

### FIELD

The present disclosure relates to melt-processible compositions containing a thermoplastic hydrocarbon polymer, a hyper-branched polyol polymer processing additive and high levels of a hindered amine light stabilizer.

### SUMMARY

Briefly, in one aspect, the present disclosure provides compositions comprising a total weight of one or more thermoplastic hydrocarbon polymers of greater than 50% by weight based on the total weight of the composition and at least 4000 ppm of a hindered amine light stabilizer based on the total weight of all thermoplastic hydrocarbon polymers in the composition. The compositions also include a hyperbranched polyester polyol, wherein the weight ratio of the hindered amine lights stabilizer to the hyperbranched polyester polyol is at least 2:1; and a synergist for the hyperbranched polyester polyol selected from the group consisting of polyethylene glycols and poly(ethylene oxide)s.

In another aspect, the present disclosure provides methods of reducing melt defects comprising compounding the one or more thermoplastic hydrocarbon polymers, the hindered amine light stabilizer, the hyperbranched polyester polyol and the synergist to form a composition according to the present invention and extruding the composition to form a film

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates the melt fracture reduction of comparative examples using a fluorinated polymer processing additive in compositions containing 4000-10,000 ppm of a HALS.

FIG. 2 illustrates the melt fracture reduction of an example using a hyperbranched polyester polyol and a PEG synergist in compositions containing 0-10,000 ppm of a HALS.

### DETAILED DESCRIPTION

Extrusion of polymeric materials in the formation and shaping of articles is a major segment of the plastic or polymeric articles industry. The quality of the extruded article and the overall success of the extrusion process are influenced by the interaction of the fluid material with the extrusion die. The desire for a smooth extrudate surface competes with, and must be optimized with respect to, the economic advantages of extruding a polymer composition at the fastest possible speed (for example at high shear rates).

For any melt-processable thermoplastic polymer composition, there exists a critical shear rate above which the surface of the extrudate becomes rough or distorted and below which the extrudate will be smooth. At shear rates slightly above the critical shear rate, defects in extruded thermoplastics may take the form of “sharkskin” which is a loss of surface gloss that, in more serious manifestations, appears as ridges running more or less transverse to the extrusion direction. At higher shear rates, the extrudate can undergo “continuous melt fracture” becoming grossly distorted. At rates lower than those at which continuous melt fracture is first observed, certain thermoplastics can also suffer from “cyclic melt fracture” in which the extrudate surface varies from smooth to rough.

Other problems encountered during extrusion of thermoplastic polymers include build-up of the polymer at the orifice of the die (known as die build up or die drool), high back pressure during extrusion runs, and excessive degradation or low melt strength of the polymer due to the need to use higher extrusion temperatures to overcome these issues. These problems slow the extrusion process either because the process must be stopped to clean the equipment or because the process must be run at a lower speed.

Additives for polymer processing (also referred to as “polymer processing additives” or “PPA”) have been used to address such problems. PPAs can reduce melt stagnation at the die and increase the shear rates at which thermoplastic polymers may be extruded without visible melt defects. Fluoropolymers are commonly used as polymer processing additives. In some instances, the performance of fluorinated PPAs can be enhanced by incorporating a “synergist.”

Recently, a new class of non-fluorinated PPAs has been discovered. As described in International Patent Application No. PCT/IB2022/060567 (“Synergists for Hyperbranched Polyol Polymer Processing Additives”), hyperbranched polyols can be effective polymer processing additives when combined with a synergist. As described in U.S. Provisional Patent Application No. 63/371,301 (“Hyperbranched Polyester Polyol Polymer Processing Additives”), certain hyperbranched polyester polyols can be effective PPAs even without the addition of synergists.

In some applications light stabilizers, e.g., hindered amine light stabilizers (“HALS”) are included in the composition. Particularly for applications where the polymeric product will be exposed to sunlight for extended periods of time (e.g., greenhouse films and agricultural films), very high loadings of HALS are used to ensure long life with little or no degradation.

The addition of HALS to compositions containing fluoroelastomer PPAs often results in a decrease in performance. It is believed that this interference stems from a combination of (i) acid-base reactions between the fluoroelastomer PPA and HALS, which causes a degradation of the fluoroelastomer PPA, and (ii) die site competition between the fluoroelastomer PPA and the HALS. At higher loading levels of some HALS, many PPAs fail to provide any benefit. Surprisingly, the present inventors discovered that hyperbranched polyester polyols were effective as polymer processing additives even in the presence of very high loadings of HALS.

Generally, the compositions of the present disclosure contain a melt-processible thermoplastic hydrocarbon polymer, a hindered amine light stabilizer, a hyperbranched polyester polyol polymer processing additive and a synergist for the polymer processing additive. Other components may be present as well.

Melt-Processible thermoplastic hydrocarbon polymers. Melt-processible polymers or resins are generally thermoplastic materials, or materials that flow when heated sufficiently above their glass transition point and become solid when cooled. They may also have elastomeric properties.

In some cases, the thermoplastic polymers comprise hydrocarbon polymers obtained by the homopolymerization or copolymerization of olefins. Suitable olefins have the general structure CH₂═CHR, where R is a hydrogen or an alkyl radical, and generally, the alkyl radical contains not more than 10 carbon atoms and preferably one to four carbon atoms. Representative olefins are ethylene, propylene, and butene-1. Representative examples of olefinic polymers include polyethylene, polypropylene, polybutene-1, poly(3-methylbutene), poly(4-methylpentene) and copolymers of ethylene with propylene, butene-1, hexane-1, octene-1, decene-1,4-methyl-1-pentene and octadecene-1.

Representative blends of thermoplastic hydrocarbon polymers useful in this invention are blends of polyethylene and polypropylene, low-density polyethylene and high-density polyethylene, and polyethylene and olefin copolymers containing copolymerizable monomers, some of which are described above, e.g., ethylene and acrylic acid copolymers; ethylene and methyl acrylate copolymers; ethylene and ethyl acrylate copolymers; ethylene and vinyl acetate copolymers; ethylene, acrylic acid, and ethyl acrylate copolymers, and ethylene, acrylic acid, and vinyl acetate copolymers.

Thermoplastic polymers may be used in the form of powders, pellets, granules, or any other extrudable form. In some cases, the thermoplastic polymer may contain other additives such as, e.g., anti-blocking agents, anti-slip agents, colorants, anti-oxidants and fillers.

Hindered amine light stabilizers. In a general sense, hindered amine light stabilizers are chemical compounds containing a functional group surrounded by a crowded steric environment. Generally, hindered amine light stabilizers (HALS) are molecules that generally do not absorb UV radiation, but act to inhibit degradation of a polymer to which they are added. Generally, they act to slow down the photochemically initiated degradation reactions of the polymer, in some regards similar to the mechanism by which antioxidants function.

The hindered amine light stabilizers useful in the compositions of the present description are not particularly limited. In some cases, the hindered amine light stabilizers are selected from compounds having the general formula:

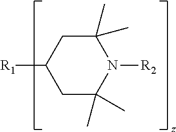

wherein R₁ is hydrogen (H) or an organic moiety having a valency of z. In some cases, R₂ is H such that the HALS is a secondary amine. In some cases, R₂ is an organic moiety having a valency of one such that the HALS is a tertiary amine. In some cases, R₂ is an organic moiety having a valency of one that comprises one or more oxygen atoms, including those resulting in an ether linkage to the nitrogen atom, sometimes referred to as amine oxides or alkoxy-amines.

Secondary hindered amine light stabilizers include those available under the tradename RIASORB from Rianlon Corporation and those available under the tradename TINUVIN from BASF Corporation. Tertiary hindered amine light stabilizers include those available under the tradenames TINUVIN and CHIMASORB from BASF Corporation. Alkoxy-amine, hindered amine light stabilizers include those available under the tradename TINUVIN from BASF Corporation.

Generally, the melt-processible compositions containing very high loadings of the HALS. In some cases, the composition contains at least 4000 parts by weight per million parts by weight of the thermoplastic hydrocarbon polymer (i.e., 4000 ppm by weight of the thermoplastic hydrocarbon polymer). In some cases, the composition contains at least 6000, at least 8000, or even at least 10,000 ppm of HALS by weight based on the weight of the thermoplastic hydrocarbon polymer. Although higher loadings may be use, generally, the HALS is present at no greater than 30,000 ppm, e.g., no greater than 20,000 ppm, or even no greater than 15,000 ppm by weight of the HALS based on the weight of the thermoplastic hydrocarbon polymer. If more than one thermoplastic hydrocarbon polymer is used, the amount of the HALS is based on the total weight of all thermoplastic hydrocarbon polymers present in the composition.

Hyperbranched polyester polyol polymer processing additives. Hyperbranched polymers are known in the art. Hyperbranched polymers are similar to dendrimers in that both are characterized by a highly branched 3-dimensional structure. All bonds emanate from a core, with a branch juncture are each monomer unit and a multiplicity of reactive chain ends. A branching generation is composed of structural units which are bound radially to the core or to the structural units of a previous generation and which extend outwards. The structural units have at least two monofunctional groups and/or at least one monofunctional group and one multifunctional group. The term multifunctional is understood as having a functionality of 2 or higher. To each functionality, a new structural unit may be linked, a higher branching generation being produced as a result. Unlike dendrimers, hyperbranched polymers have an irregular structure and positioning of their functional groups; thus, while dendrimers are described as having precise “generations,” hyperbranched polymers are described as having “pseudo-generations.” The resulting hyperbranched polymers have a core, at least one branching pseudo-generation and an external surface composed of functional end groups.

Hyperbranched polymers of the polyester type are described in, e.g., International Publication Number WO 96/12754 and U.S. Pat. No. 6,300,424 B1.

As used herein, a “hyperbranched polyester polyol” refers to a hydroxy-functional, hyperbranched polyester in which at least 90 mole % of the functional end groups are hydroxy groups, e.g., in some cases, at least 95 or even 100 mole % of the functional end groups are hydroxy groups. The term “hyperbranched polyester polyol” distinguishes the hydroxy-functional, hyperbranched polyesters of the present disclosure from functionalized hyperbranched polyesters in which a higher percentage (e.g., 50%, 90% or even 100%) of the hydroxy groups are replaced with, e.g., fatty acid or amine functional groups. Suitable hyperbranched polyester polyols are available from Perstorp AB under the trade name BOLTORN, e.g., BOLTORN H20 (reported to be a pseudo generation 2 with 16 hydroxyl functional groups), H30 (reported to be a pseudo generation 3 with 32 hydroxyl functional groups), and H40 (reported to be a pseudo generation 4 with 64 hydroxyl functional groups). These hyperbranched polyester polyols are described as having 2,2-bis(methylol)propionic acid (“bis-MPA”) branching units.

Generally, the melt-processible compositions containing the minimal amount of the hyperbranched polyester polyol polymer processing additive needed to deliver the desired performance, i.e., pressure reduction and melt-fracture elimination. In some cases, the melt-processible compositions contain no greater than 5000 parts by weight of the PPA per million parts by weight of the thermoplastic hydrocarbon polymer. In some cases, the melt-processible compositions contain no greater than 3000, no greater than 2000, or even no greater than 1000 ppm by weight of the PPA based on the weight of the thermoplastic hydrocarbon polymer. In some cases, the melt-processible compositions contain at least 100, e.g., at least 300 ppm, or even at least 400 ppm by weight of the PPA based on the weight of the thermoplastic hydrocarbon polymer. For example, in some cases, the melt-processible compositions comprise 100 to 3000, e.g., 200 to 2000, or 300 to 1000 ppm by weight of the PPA based on the weight of the thermoplastic hydrocarbon polymer. If more than one thermoplastic hydrocarbon polymer is used, the amount of the PPA is based on the total weight of all thermoplastic hydrocarbon polymers present in the composition.

In some cases, the weight ratio of the HALS to the hyperbranched polyester polyol polymer processing additive is at least 2:1. In some cases, this weight ratio is at least 4:1, at least 8:1, at least 12:1, or even at least 15:1. Although not particularly limited, in some cases, the weight ratio of the HALS to the hyperbranched polyester polyol polymer processing additive is no greater than 30:1 or no greater than 25:1.

The melt-processible compositions further comprise a synergist for the hyperbranched polyester polyol polymer processing additive. Generally, synergists have been considered optional components that, when combined with a polymer processing additive, further reduce the time to melt fracture, further improve the pressure reduction of extrusion, reduce the amount of the hyperbranched polyester polyol polymer processing additive required to maintain the same or similar performance, or some combination thereof. The present inventors discovered that the presence of a synergist when compositions with high HALS contents were used.

Suitable synergists include polyethylene glycols (“PEG”) and poly(ethylene oxide)s (“PEO”). Generally, PEG and PEO have the same chemical structure and differ only in the starting materials used in their formation and molecular weight. The number average molecular weight may be measured by Gel Permeation Chromatography (GPC) using polyethylene glycol and poly(ethylene oxide) standards. GPC equipment and standards are available from Agilent Technologies, Inc.

Suitable synergists include polyethylene glycols (“PEG”) and poly(ethylene oxide)s (“PEO”). Generally, PEG and PEO have the same chemical structure and differ only in the starting materials used in their formation, their molecular weights, and the resulting end-groups. In some cases, the PEG/PEO synergists have a number average molecular weight of 1000 to 500,000 Daltons, e.g., 4000 to 300,000 Daltons, 4000 to 100,000 Daltons, or even 4000 to 20,000 Daltons. In some cases, the polyethylene glycols have a number average molecular weight of 1000 to 50,000 Daltons, e.g., 4000 to 25,000 Daltons. In some cases, the poly(ethylene oxide)s have a number average molecular weight of 10,000 to 500,000 Daltons, e.g., 15,000 to 400,000 Daltons. The number average molecular weight may be measured by Gel Permeation Chromatography (GPC) using polyethylene glycol and poly(ethylene oxide) standards. GPC equipment and standards are available from Agilent Technologies, Inc.

In some cases, the weight ratio of the hyperbranched polyester polyol to the synergist in the polymer processing additive composition is from 90:10 to 10:90. In some cases, the weight ratio is 75:25 to 25:75, or even 60:40 to 40:60.

As it may be difficult to control the amounts of additives such as the polymer processing additive, the synergist and the HALS at such low levels, in some cases, master batches may be used. Such a master batch contains a higher proportion of the additive in a host resin. The host resin is selected to be compatible with the thermoplastic polymer and may be the same or different than the thermoplastic polymer. The amount of the additive in the master batch is not critical. In some cases, the master batches contain 0.5 to 30 wt. %, e.g., 1 to 20 wt. % of the additive. In some cases, two or more additives may be combined in a single master batch. In some cases, when multiple additives are present in the master batch, they are present in their desired weight ratio for final compounding. However, in some cases, master batches with a single additive may be prepared and used with multi-component master batches to achieved the desired final composition.

Known equipment and methods may be used both to compound the various additives into the thermoplastic polymer and to process the resulting composition. For example, the polymer processing additives of the present disclosure are useful in the processing of thermoplastic polymers, using techniques such as film extrusion and extrusion blow molding.

Examples. The materials used to prepare the polymer processing additive compositions used in the following examples are summarized in Table 1.

TABLE 1
Summary of materials used in the preparation of the examples.

| Name | Description | Trade Name and Source |
|---|---|---|
| LLDPE-1 | Linear low-density polyethylene | EXXONMOBIL LL1201AY from |
| | (Melt flow index = 0.7) | ExxonMobil Company |
| LLDPE-2 | Linear low-density polyethylene | EXXONMOBIL LL1002AY |
| HALS-A | Hindered amine light stabilizer | CHIMASSORB 994 from BASF |
| PPA-F1 | Fluorinated PPA | DYNAMAR FX5922 from 3M Company |
| PPA-F2 | Fluorinated PPA | DYNAMAR FX5920A from 3M Company |
| PPA-F3 | Fluorinated PPA | VITON Z210 from The Chemours Co. |
| PPA-F4 | Fluorinated PPA | INOLUB P402F from Gujarat |
| | | Fluorochemicals, Ltd. |
| PPA-F5 | Fluorinated PPA | Copolymer of vinylidene fluoride and |
| | | tetrafluoroethylene as described in U.S. |
| | | Pat. No. 11,312,802 |
| PPA-HPP1 | Hyperbranched polyester polyol | BOLTORN H20 from Perstorp AB |
| PEG | polyethylene glycol | INEOS PEG 8000 (8000 MW) |
| PCL | polycaprolactone | 4000 MW from Ingevity Corp. |

Individual master batches were prepared by combining each PPA (including a synergist, if used) with LLDPE-2 and a phenolic antioxidant (IRGANOX B 900 from BASF). The resulting mixture was fed to twin-screw extruder (BERSTORFF ZE 25A with 25 mm co-rotating screws, an L/D=40 and a 3.5 mm round die). The zone temperatures were 50/160/180/190° C. in zones 1-4, respectively; and 200° C. in zones 5-10. The die and melt temperatures were 200° C. The screw speed was 125 rpm resulting in an output of 3.5 kg/hour. Each master batch contained 2.0 or 3.0 wt. % of the PPA (or PPA plus synergist) and 500 ppm of the antioxidant, each based on the total weight of the master batch.

The HALS was obtained as a 20 wt. % masterbatch of the CHIMASSORB 994 hindered amine light stabilizer obtained from Constab Ger.

Blown Film Procedure. Extruded films were prepared by feeding the master batches and the LLDPE resin to Zone 1 of a ten-zone blown film line. The extruder was a COLLIN Lab Line E45P extruder having a screw diameter of 45 mm, a die gap or 0.8 mm and a die diameter of 50 mm. The length to diameter ratio was 30 and the compression ratio was 2.96. The temperature profile was 40/160/195/200/205/210/215/215/215/215° C. The output of the resulting blown film was 10.2 kg/hr resulting in a shear rate of 220 sec⁻¹ at a melt temperature of 210° C. T

TABLE 2
Summary of examples and comparative examples
(ppm based on weight of LLDPE).

| | | |
|---|---|---|
| PPA | Synergist | HALS |

| Sample | Type | ppm | Type | ppm | (ppm) |
|---|---|---|---|---|---|
| CE-A1 | PPA-F1 | 1000 | None | | 4000 |
| CE-A2 | PPA-F1 | 1000 | None | | 6000 |
| CE-A3 | PPA-F1 | 1000 | None | | 8000 |
| CE-A4 | PPA-F1 | 1000 | None | | 10,000 |
| REF-B1 | PPA-HPP1 | 500 | PEG | 500 | 0 |
| EX-B2 | PPA-HPP1 | 500 | PEG | 500 | 4000 |
| EX-B3 | PPA-HPP1 | 500 | PEG | 500 | 8000 |
| EX-B4 | PPA-HPP1 | 500 | PEG | 500 | 10,000 |
| CE-C1 | PPA-HPP1 | 1000 | None | | 8000 |
| CE-C2 | PPA-HPP1 | 500 | PCL | 500 | 8000 |
| EX-C3 | PPA-HPP1 | 500 | PEG | 500 | 8000 |
| CE-D1 | PPA-F2 | 1000 | None | | 4000 |
| CE-D2 | PPA-F1 | 1000 | None | | 8000 |
| CE-D3 | PPA-F2 | 1000 | None | | 8000 |
| CE-D4 | PPA-F5 | 500 | PEG | 500 | 8000 |
| CE-D5 | PPA-F3 | 1000 | None | | 10,000 |
| CE-D6 | PPA-F5 | 500 | PEG | 500 | 10,000 |
| CE-D7 | PPA-F4 | 1000 | None | | 10,000 |

Polymer processing additives are used to reduce or eliminate melt fracture melt fracture. Melt fracture can be determined by collecting samples over time. The samples are visually inspected and the melt fracture, expressed as a percentage of the film area covered with melt fracture (MF) is reported. If the melt fracture is reduced to zero, the time to eliminate melt fracture (TTC) is reported in minutes. In Table 3, if some level of melt fracture remained when the experiment is completed, the remaining melt fracture was report as a percent (MF) along with the time (Time) the experiment was completed. Generally, if melt fracture was not fully cleared within 60-90 minutes, the experiments were concluded.

Polymer processing additives are also used to reduce the melt pressure during extrusion. The pressure reduction is the difference between the initial pressure and the final pressure reported as a percent of the initial pressure (Pred) in Table 3.

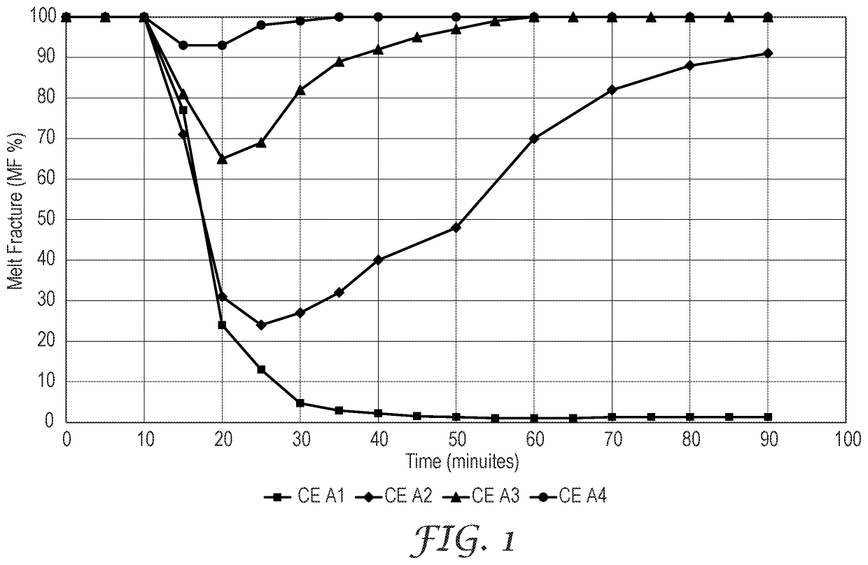

Comparative Examples A1 to A4. The compositions were prepared by combining the LLDPE with a fluorinated polymer processing additive (PPA-F1) at 1000 ppm based on the weight of the LLDPE polymer, and various amounts of HALS, as summarized in Table 2. The compositions were extruded according to the Blown Film Procedure. Samples were collected every five minutes, and the film was examined for the presence of melt fracture (MF), expressed as a percentage of the film area covered with melt fracture. As shown in FIG. 1 and Table 3, melt fracture was nearly, but not completely, eliminated only at the lowest HALS loading (4000 ppm). As the HALS loading increased to 6000 ppm and above, the fluorinated PPA failed to provide any beneficial melt fracture reduction. Instead, as the trials with higher loadings continued, the melt fracture approached or reached 100%. As reported in Table 3, the pressure reduction decreased from 6% to 3% as the amount of HALS was increased from 4000 to 10,000 ppm.

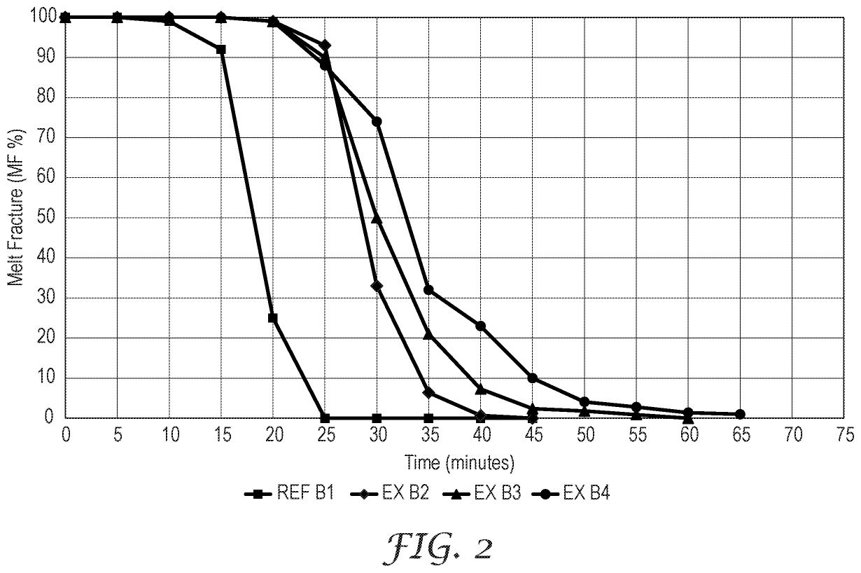

Reference Example B1 and Examples B2 to B4. The compositions were prepared by combining the LLDPE with a hyperbranched polyester polyol (PPA-HPP1) and the polyethylene glycol synergist (PEG), both at 500 ppm based on the weight of the LLDPE polymer, and various amounts of HALS, as summarized in Table 2. The compositions were extruded according to the Blown Film Procedure. Samples were collected every five minutes, and the film was examined for the presence of melt fracture (MF), expressed as a percentage of the film area covered with melt fracture. As shown in FIG. 2 and Table 3, the time to clear melt fracture increased and the pressure reduction obtained decreased when HALS was added at 4000 ppm as compared to REF-B1 with no HALS; however, melt fracture was still eliminated in only 45 minutes. Even as the HALS was further increased to 8000, melt fracture was eliminated and at 10,000 only 1% MF remained after 65 minutes. Significant pressure reductions (i.e., 12-13%) were obtained at all HALS loadings.

Comparative Examples C1 and C2 and Example C3. The compositions were prepared by combining the LLDPE with a hyperbranched polyester polyol alone (Comparative Example C1), with the polycaprolactone synergist (Comparative Example C2) and with polyethylene glycol synergist (Example C3 and 80000 ppm of HALS, as summarized in Table 2. The compositions were extruded according to the Blown Film Procedure. Samples were collected every five minutes, and the film was examined for the presence of melt fracture (MF), expressed as a percentage of the film area covered with melt fracture. As shown in Table 3, Example C3, which combined the hyperbranched polyester polyol PPA with the polyethylene glycol synergist eliminated melt fracture and provided a pressure reduction of 14%. In contrast when no synergist was used (C1) or polycaprolactone was used as the synergist (C2), significant melt fracture remained after 60 minutes, and pressure reductions of 5% or less were obtained.

Comparative Examples D1 to D7. Compositions were prepared by combining the LLDPE with various PPAs at 1000 ppm in combination with 4000, 8000 and 10,000 ppm of HALS, based on the weight of the LLDPE polymer, as summarized in Table 2. A variety of fluorinated PPAs were used, including samples with a PEG synergist. The compositions were extruded according to the Blown Film Procedure. Samples were collected every five minutes, and the film was examined for the presence of melt fracture (MF), expressed as a percentage of the film area covered with melt fracture. These fluorinated PPAs, including those which included the PEG synergist, failed to provide significant melt fracture reduction in the presence of the HALS. Also, the pressure reductions never exceeded 5%.

TABLE 3
Time to clear melt fracture (TTC), Melt fracture
(MF) and pressure reduction (Pred).

| | | | HALS | TTC | | Time | |
|---|---|---|---|---|---|---|---|
| Sample | PPA | Synergist | (ppm) | (min) | MF | (min) | Pred |
| CE-A1 | F1 | None | 4000 | | 1.3 | 90 | 6% |
| CE-A2 | F1 | None | 6000 | | 91 | 90 | 4% |
| CE-A3 | F1 | None | 8000 | | 100 | 90 | 3% |
| CE-A4 | F1 | None | 10,000 | | 100 | 90 | 3% |
| REF-B1 | HPP1 | PEG | 0 | 25 | | | 31% |
| EX-B2 | HPP1 | PEG | 4000 | 45 | | | 13% |
| EX-B3 | HPP1 | PEG | 8000 | 60 | | | 12% |
| EX-B4 | HPP1 | PEG | 10,000 | | 1 | 65 | 12% |
| CE-C1 | HPP1 | None | 8000 | | 100 | 60 | 2% |
| CE-C2 | HPP1 | PCL | 8000 | | 85 | 60 | 5% |
| EX-C3 | HPP1 | PEG | 8000 | 50 | | | 14% |
| CE-D1 | F2 | None | 4000 | | 14 | 60 | 4% |
| CE-D2 | F1 | None | 8000 | | 71 | 60 | 5% |
| CE-D3 | F2 | None | 8000 | | 98 | 60 | 3% |
| CE-D4 | F5 | PEG | 8000 | | 99 | 70 | 4% |
| CE-D5 | F3 | None | 10,000 | | 99 | 60 | 3% |
| CE-D6 | F5 | PEG | 10,000 | | 100 | 60 | 3% |
| CE-D7 | F4 | None | 10,000 | | 100 | 60 | 3% |

Various modifications and alterations of this invention will become apparent to those skilled in the art without departing from the scope and spirit of this invention.

1. A composition comprising a total weight of one or more thermoplastic hydrocarbon polymers of greater than 50% by weight based on the total weight of the composition; at least 4000 ppm of a hindered amine light stabilizer based on the total weight of all thermoplastic hydrocarbon polymers in the composition; a hyperbranched polyester polyol, wherein the weight ratio of the hindered amine lights stabilizer to the hyperbranched polyester polyol is at least 2:1; and a synergist for the hyperbranched polyester polyol selected from the group consisting of polyethylene glycols and poly(ethylene oxide)s.

2. The composition of claim 1, wherein the synergist comprises a polyethylene glycol.

3. The composition of claim 2, wherein the polyethylene glycol has a number average molecular weight of 4000 to 25,000 as measured by gel permeation chromatography.

4. The composition of claim 2, wherein the weight ratio of the hyperbranched polyester polyol to the synergist is from 75:25 to 25:75, inclusive.

5. The composition of claim 1, comprising at least 90% by weight of the one or more thermoplastic hydrocarbon polymers.

6. The composition of claim 1, comprising at least 8000 ppm of the hindered amine light stabilizer based on the total weight of all thermoplastic hydrocarbon polymers in the composition.

7. The composition of claim 1, comprising no greater than 30,000 ppm of the hindered amine light stabilizer based on the total weight of all thermoplastic hydrocarbon polymers in the composition.

8. The composition of claim 1, wherein the weight ratio of the hindered amine lights stabilizer to the hyperbranched polyester polyol is at least 4:1.

9. The composition of claim 8, wherein the weight ratio of the hindered amine lights stabilizer to the hyperbranched polyester polyol is at least 8:1.

10. The composition of claim 1, comprising 100 to 3000 ppm of the hyperbranched polyester polyol based on the total weight of all thermoplastic hydrocarbon polymers in the composition.

11. The composition of claim 10, comprising 500 to 1500 ppm of the hyperbranched polyester polyol based on the total weight of all thermoplastic hydrocarbon polymers in the composition.

12. The composition of claim 1, wherein at least one of the thermoplastic hydrocarbon polymers comprises a polyolefin.

13. The composition of claim 12, wherein the polyolefin is a polyethylene.

14. The composition of claim 13, wherein the polyethylene is a liner low density polyethylene.

15. The composition of claim 12, comprising a second thermoplastic hydrocarbon polymer different from the polyolefin.

16. The composition of claim 1, wherein branches of the hyperbranched polyester polyol comprise polymerized units of 2,2-dimethylol propionic acid.

17. The composition of claim 1, wherein the hyperbranched polyester polyol comprises from 16 to 64 hydroxyl functional groups.

18. A method of reducing melt defects comprising compounding the one or more thermoplastic hydrocarbon polymers, the hindered amine light stabilizer, the hyperbranched polyester polyol and the synergist to form the composition of claim 1 and extruding the composition to form a film.

19. The method of claim 18, wherein extruding comprises melt-blown extrusion.

20. A film comprising the composition of claim 1.
